(19) United States
(12) Patent Application Publication
(10) Pub. No.: US 2015/0060494 A1
(43) Pub. Date: Mar. 5, 2015

(54) MOUTHWASH BOTTLE WITH A PUMP, A BASE AND AN INSERTABLE CUP

(71) Applicant: Children Oral Care, LLC, Buena Park, CA (US)

(72) Inventors: Doug Corbett, New Canaan, CT (US); David Louis Keener, III, Stanton, CA (US); Huy Kha Nguyen, Anaheim, CA (US)

(21) Appl. No.: 14/469,311

(22) Filed: Aug. 26, 2014

Related U.S. Application Data
(60) Provisional application No. 61/870,981, filed on Aug. 28, 2013.

(51) Int. Cl. B05B 11/00

(52) U.S. Cl. CPC B05B 11/0037; B05B 11/0078; B05B 11/30
USPC 222/173; 222/192

(57) ABSTRACT

A mouthwash dispensing system includes a bottle having a neck defining a top opening and a reservoir having side surfaces and a bottom surface that curves downward towards a center point, a pump mechanism having a pump and a tube extending from the pump and into the reservoir, the tube defining an axis that is coincident with the center point, a base having a top portion for connecting to the bottom surface of the bottle, a front portion defining a cup opening, and left and right protrusions located within the cup opening, and a cup having a top rim portion, a fluid portion and a handle having a flat surface portion extending from the top rim portion and a front holding portion, the cup configured to fit into the cup opening such that the top rim portion is positioned inside the left and right protrusions.

### CROSS REFERENCE TO RELATED APPLICATIONS

This application claims the benefit and priority of U.S. Provisional Application No. 61/870,981, entitled “Mouthwash Bottle with a Pump, a Base and an Insertable Cup,” filed on Aug. 28, 2013, the entire disclosure of which is hereby incorporated by reference herein.

### BACKGROUND

1. Field of the Invention

The present invention relates to mouthwash bottles, and more particularly to a mouthwash bottle with a pump, a base and an insertable cup.

2. Description of the Related Art

Many mouthwash bottles are currently available. Generally, these mouthwash bottles have caps that cover the bottle openings but can also be turned over and used as a cup. For example, a user can take the cap off the mouthwash bottle, turn it over, and then pour the mouthwash into the cap for use in his/her mouth. Once the mouthwash is used, the user generally washes out the cap with water and then places it back on the bottle. In some instances, the user's germs on and/or the water in the cap can drip into the mouthwash, thus contaminating or diluting the mouthwash. Accordingly, there is a need for a mouthwash bottle that is easy to use, clean and mess-free, and allows for proper use.

### SUMMARY OF THE INVENTION

According to some embodiments, a mouthwash dispensing system includes a bottle having a neck defining a top opening and a reservoir having side surfaces and a bottom surface and a pump mechanism having a pump and a tube extending from the pump and into the reservoir for carrying fluid from the reservoir to the pump. The mouthwash dispensing system also includes a base having a top portion for connecting to the bottom surface of the bottle, a bottom portion for placement on a surface and a front portion defining a cup opening and a cup having a top rim portion, a fluid portion and a handle having a flat surface portion extending from the top rim portion and a front holding portion, the cup configured to be fitted into the cup opening.

According to some embodiments, a mouthwash dispensing system includes a bottle having a neck defining a top opening and a reservoir having side surfaces and a bottom surface that curves downward towards a center point, a pump mechanism having a pump and a tube extending from the pump and into the reservoir, the tube defining an axis that is coincident with the center point, a base having a top portion for connecting to the bottom surface of the bottle, a bottom portion for placement on a surface, a front portion defining a cup opening, and left and right protrusions located within the cup opening, and a cup having a top rim portion, a fluid portion and a handle having a flat surface portion extending from the top rim portion and a front holding portion, the cup configured to fit into the cup opening such that the top rim portion is positioned inside the left and right protrusions, which are used to hold the cup within the cup opening.

### BRIEF DESCRIPTION OF THE DRAWINGS

The features and advantages of the embodiments of the present disclosure will become more apparent from the detailed description set forth below when taken in conjunction with the drawings. Naturally, the drawings and their associated descriptions illustrate example arrangements within the scope of the claims and do not limit the scope of the claims. Reference numbers are reused throughout the drawings to indicate correspondence between referenced elements.

FIG. 1 is a front view of a mouthwash bottle with a base according to an embodiment of the invention.

FIG. 2 is a front view of the mouthwash bottle with a pump mechanism according to an embodiment of the invention.

FIG. 3 is a bottom view of the mouthwash bottle showing the bottom surface curve downward towards the center area according to an embodiment of the invention.

FIG. 4 is a top view of the base showing the cup opening and the cup positioned within the cup opening according to an embodiment of the invention.

FIG. 5 is a top view of the cup having a handle and a front holding portion according to an embodiment of the invention.

FIG. 6 is a front view of the cup and the front holding portion according to an embodiment of the invention.

### DETAILED DESCRIPTION

In the following detailed description, numerous specific details are set forth to provide an understanding of the present disclosure. It will be apparent, however, to one of ordinarily skilled in the art that elements of the present disclosure may be practiced without some of these specific details. In other instances, well-known structures and techniques have not been shown in detail to avoid unnecessarily obscuring the present disclosure.

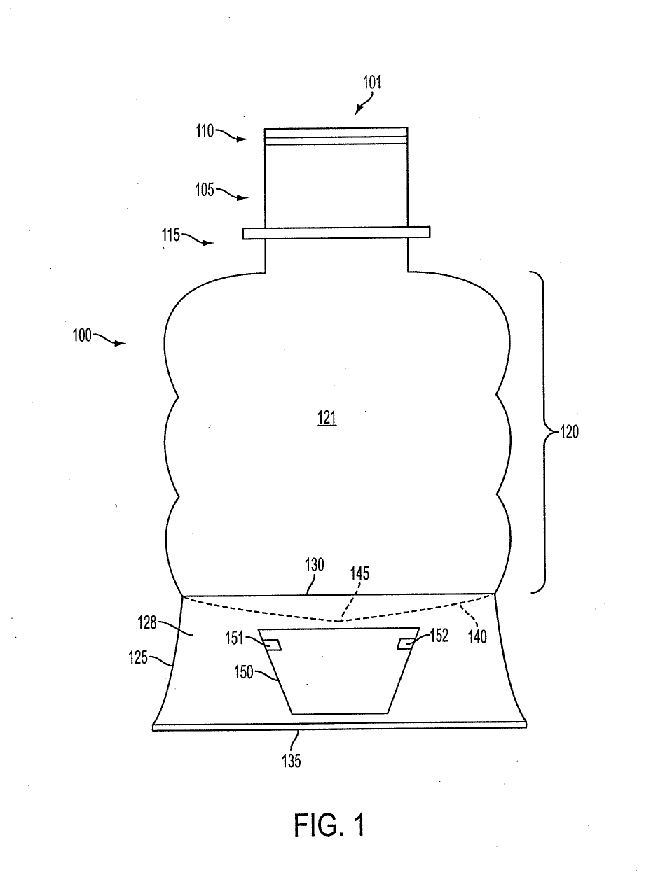

FIG. 1 is a front view of a mouthwash bottle 100 with a base 125 according to an embodiment of the invention. The mouthwash bottle 100 has a neck 105 defining a top opening 101 and a reservoir 121 having side surfaces 120 (e.g., left, right, front and rear sides which form a somewhat rectangular cross-section in both the vertical and horizontal directions) and a bottom surface 140 that curves downward towards a center area 145. That is, the bottom surface 140 curves downward towards the center area 145 so that as fluid (i.e., the mouthwash) is emptied from the reservoir 121, the remaining fluid will accumulate at the lowest portion of the reservoir 121, which is the center area 145. This center area 145 advantageously allows the pump mechanism (described below) to extract all (or mostly all) of the fluid from the reservoir 121 since the tube (described below) of the pump mechanism is aligned or coincident with the center area 145 of the mouthwash bottle 100.

The mouthwash bottle 100 sits on top of the base 125, which is used as support. In one embodiment, the mouthwash bottle 100 is permanently fixed to the base 125. When the mouthwash bottle 100 has a curved bottom surface 140, it is preferable to use the base 125 so that the mouthwash bottle 100 does not easily tip over. In one embodiment, the mouthwash bottle 100 can have a flat bottom surface 140.

The neck 105 has grooves 110 for screwing in the pump mechanism, which closes the top opening 101 of the mouthwash bottle 100. Also, a rim 115 circles around the entire neck 105 to allow a user to more easily hold the mouthwash bottle 100.

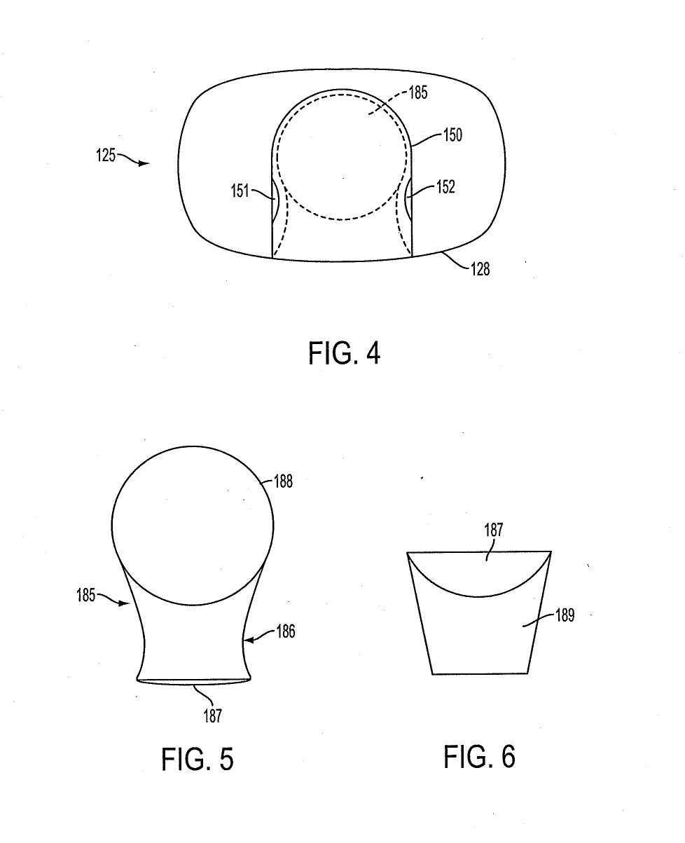

The base 125 has a top portion or rim 130 for connecting or attaching to the side surfaces 120 and/or the bottom surface 140 of the mouthwash bottle 100. Hence, the base 125 is located below or beneath the mouthwash bottle 100. The base 125 is sized and configured to receive the mouthwash bottle 100 such that the center area 145 extends into the base 125 to provide a better fit and allow the mouthwash bottle 100 to have a convex bottom surface 140. The base 125 has a bottom portion 135 for placement on a surface such as a bathroom countertop or other relatively flat surfaces. The base 125 has a front portion 128 defining a cup opening 150. The cup opening 150 is open space that begins at the front portion 128 of the base 125 and extends into the base 125 to allow a cup 185 to be inserted therein for securely storing the cup 185 within the base 125 (see also FIG. 4). In one embodiment, left and right protrusions 151 and 152 are used to hold the cup 185 within the cup opening 150. In one embodiment, the cup opening 150 is formed in the shape of a trapezoid, where the top and bottom sides are parallel to one another and the left and right sides are angled such that the bottom of the cup opening 150 has a smaller linear distance that the top of the cup opening 150. In one embodiment, the cup opening 150 is sized and shaped to snugly fit the cup 185. In one embodiment, the cup opening 150 can be in the shape of a square or a rectangle.

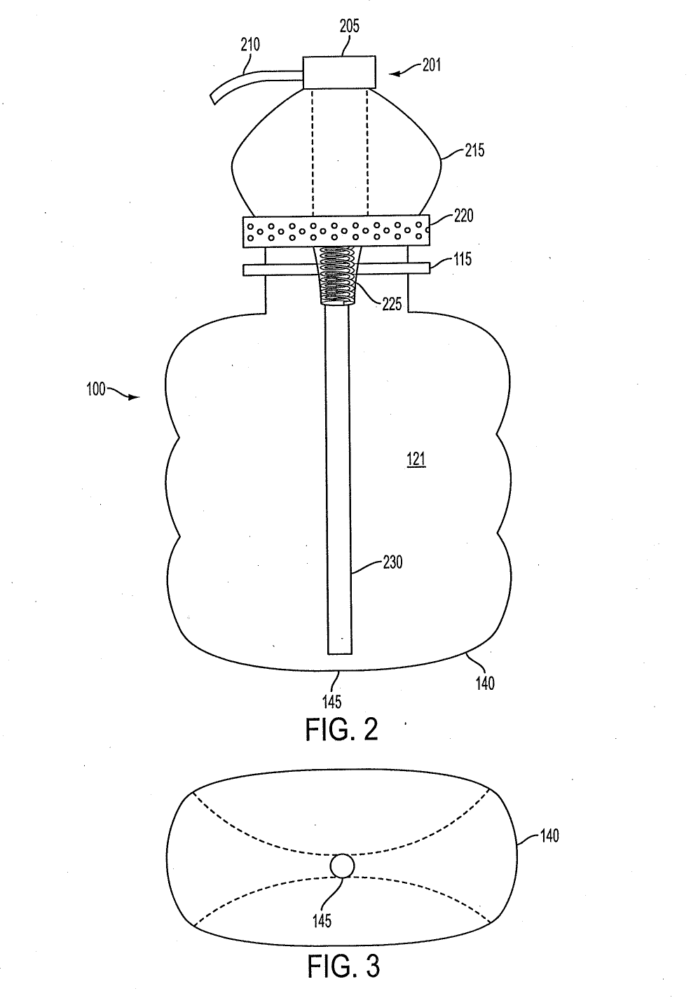

FIG. 2 is a front view of the mouthwash bottle 100 with a pump mechanism 201 according to an embodiment of the invention. The pump mechanism 201 includes a pump top 205 that is configured to move up and down to extract fluid from the reservoir 121, a pump nozzle 210 extending from the pump top 205, a spring 225 that assists in moving the pump top 205 up and down and a tube 230 extending from the pump spring 225 and into the reservoir 121. As the pump top 205 is pushed down, fluid from the reservoir 121 is pulled into the tube 230 and travels to the pump nozzle 210, where it exists into the cup 185.

The tube 230 defines an axis that is coincident with the center area 145. The pump mechanism 201 may also include a decorative character or ball 215 with an ornamental design thereon and a gripping collar or rim 220 that is used to grasp with the fingers to screw and unscrew the pump mechanism 201 to the mouthwash bottle 100. The ball 215 may move up and down with the pump top 205 or may be stationary or fixed as the pump top 205 moves up and down. The ball 215 may also be used to hold or grab the mouthwash bottle 100.

FIG. 3 is a bottom view of the mouthwash bottle 100 (without the base 125) showing the bottom surface 140 curve downward towards the center area 145 so that as fluid (i.e., the mouthwash) is emptied from the reservoir 121, the remaining fluid will accumulate at the lowest portion of the reservoir 121, which is the center area 145. This center area 145 advantageously allows the pump mechanism 201 (see FIG. 2) to extract all (or most all) of the fluid from the reservoir 121 since the tube 230 (see FIG. 2) of the pump mechanism is aligned or coincident with the center area 145. Also, the tube 203 extends to be less than 5 millimeters from the center area 145 of the bottom surface 140.

FIG. 4 is a top view of the base 125 showing the cup opening 150 and the cup 185 positioned within the cup opening 150 according to an embodiment of the invention. The cup 185 fits within the cup opening 150 and is held in place and within the cup opening 150 by left and right protrusions 151 and 152. A user can push the cup 185 into the cup opening 150 so that a top rim 188 (see FIG. 5) passes over the left and right protrusions 151 and 152. A body 189 (see FIG. 6) of the cup 185 is used to hold the fluid and contacts the left and right protrusions 151 and 152 as the cup 185 is inserted into the cup opening 150 for storage purposes. The mouthwash bottle 100, the base 125, the cup opening 150, the cup 185 and the pump mechanism 201 allow for a convenient, clean and mess-free and germ-free easy to use mouthwash dispensing system.

FIG. 5 is a top view of the cup 185 according to an embodiment of the invention. The cup 185 includes a handle having a flat surface portion 186 extending from the top rim 188 and a front holding or gripping portion 187. In one embodiment, the front holding portion 187 extends downward from the flat surface portion 186 for ease of holding and pulling in and out of the cup opening and the front holding portion 187 may be substantially perpendicular or slightly angled relative to the flat surface portion 186. The cup 185 is configured to fit into the cup opening 150 such that the top rim 188 is positioned inside or within the left and right protrusions 151 and 152, which are used to hold the cup 185 within the cup opening 150.

FIG. 6 is a front view of the cup 185 according to an embodiment of the invention. In one embodiment, the front holding portion 187 is curved in the shape of a semi-circle for easy grasping by the fingers. This advantageously allows for easy insertion and removal of the cup 185 into and out of the cup opening 150. Also, when the cup 185 is completely inserted into the cup opening 150, the front holding portion 187 is flush with the front portion 128 of the base 125.

The foregoing description of the disclosed example embodiments is provided to enable any person of ordinary skill in the art to make or use the present invention. Various modifications to these examples will be readily apparent to those of ordinary skill in the art, and the principles disclosed herein may be applied to other examples without departing from the spirit or scope of the present invention. The described embodiments are to be considered in all respects only as illustrative and not restrictive and the scope of the invention is, therefore, indicated by the following claims rather than by the foregoing description. All changes which come within the meaning and range of equivalency of the claims are to be embraced within their scope.

What is claimed is:

1. A mouthwash dispensing system comprising:
a bottle having a neck defining a top opening and a reservoir having side surfaces and a bottom surface that curves downward towards a center area;
a pump mechanism having a pump and a tube extending from the pump and into the reservoir, the tube defining an axis that is coincident with the center area;
a base having a top portion for connecting to the bottom surface of the bottle, a bottom portion for placement on a surface, a front portion defining a cup opening, and left and right protrusions located within the cup opening; and
a cup having a top rim portion, a fluid portion and a handle having a flat surface portion extending from the top rim portion and a front holding portion, the cup configured to be fitted into the cup opening such that the top rim portion is positioned inside the left and right protrusions, which are used to hold the cup within the cup opening.

2. The mouthwash dispensing system of claim 1 wherein the front holding portion is substantially perpendicular to the flat surface portion.

3. The mouthwash dispensing system of claim 1 wherein the left and right protrusions are located towards a top portion of the cup opening.

4. The mouthwash dispensing system of claim 1 wherein the bottle is permanently fixed to the base.

5. The mouthwash dispensing system of claim 1 wherein the cup opening is formed in the shape of a trapezoid.

6. The mouthwash dispensing system of claim 1 wherein the cup fits completely within the cup opening.

7. The mouthwash dispensing system of claim 1 wherein the front holding portion is curved in the shape of a semi-circle for easy grasping by the fingers.

8. The mouthwash dispensing system of claim 1 wherein the front holding portion is flush with the front portion of the base.

9. The mouthwash dispensing system of claim 1 wherein the front holding portion is flush with the front portion of the base.

10. A mouthwash dispensing system comprising:
a bottle having a neck defining a top opening and a reservoir having side surfaces and a bottom surface;
a pump mechanism having a pump and a tube extending from the pump and into the reservoir for carrying fluid from the reservoir to the pump;
a base having a top portion for connecting to the bottom surface of the bottle, a bottom portion for placement on a surface and a front portion defining a cup opening; and
a cup having a top rim portion, a fluid portion and a handle having a flat surface portion extending from the top rim portion and a front holding portion, the cup configured to be fitted into the cup opening.

11. The mouthwash dispensing system of claim 10 wherein the base further comprises left and right protrusions located within the cup opening such that the top rim portion is positioned inside the left and right protrusions, which are used to hold the cup within the cup opening.

12. The mouthwash dispensing system of claim 10 wherein the front holding portion is substantially perpendicular to the flat surface portion.

13. The mouthwash dispensing system of claim 10 wherein the left and right protrusions are located towards a top portion of the cup opening.

14. The mouthwash dispensing system of claim 10 wherein the bottle is permanently fixed to the base.

15. The mouthwash dispensing system of claim 10 wherein the cup opening is formed in the shape of a trapezoid.

16. The mouthwash dispensing system of claim 10 wherein the cup fits completely within the cup opening.

17. The mouthwash dispensing system of claim 10 wherein the front holding portion is curved in the shape of a semi-circle for easy grasping by the fingers.

18. The mouthwash dispensing system of claim 10 wherein the front holding portion is flush with the front portion of the base.
